(19) United States
(12) Patent Application Publication
(10) Pub. No.: US 2013/0038693 A1
(43) Pub. Date: Feb. 14, 2013

(54) METHOD AND APPARATUS FOR REDUCING FRAME REPETITION IN STEREOSCOPIC 3D IMAGING

(71) Applicant: Emil Tchoukaleysky, Toronto (CA)

(72) Inventor: Emil Tchoukaleysky, Toronto (CA)

(73) Assignee: Thomson Licensing, Issy-les Moulineaux (FR)

(21) Appl. No.: 13/642,658

(22) PCT Filed: Apr. 27, 2010
(86) PCT No.: PCT/IB10/00953

§ 371 Date: Oct. 22, 2012

(51) Int. Cl. H04N 13/02; G06T 15/00

(52) U.S. Cl. 348/46; 345/419; 348/E13.074

(57) ABSTRACT

The present invention is directed towards enhancing the reproduction of three-dimensional dynamic scenes on digital light processing (DLP) and (liquid crystal display) LCD projectors and displays by adding optimal amount of motion blur to stimulate the covered eye to continue perceiving scene picture changes. Too much blur would bring smearing, but a lack of blur induces motion breaking.

### BACKGROUND

1. Technical Field

The present invention relates to 3-dimensional imaging. More specifically, it relates to a method and apparatus for reducing frame repetition in stereoscopic 3D (S3D) imaging.

2. Related Art

Currently, S3D theatres which rely on the phenomenon of sequential picture reproduction employ a single digital projector to display the images for both eyes. In this process, while one of the eye-images is projected, the other eye-image is blocked. It is assumed that the Human Visual System (HVS) can reconstruct the original volumetric scene by perceiving the eye-separated frame sequences, projected above the threshold of flicker and motion jumpiness. However, this is not always the case. If the projection frame rate is left at the standard value of 48 FPS per eye-image, the audience will observe temporal artifacts—motion judder, scene object discontinuity, breaking of the frame sequence. The present invention addresses, first and foremost, the problem of convolution between the multiplexed eye-image sequence, and the frame sequence reproducing dynamic objects. Secondly, it explores the possibilities for optimizing the popular method of multiplexing the LE-RE images for one frame in a sequence:

LE-RE-LE-RE-LE-RE

Presently, every eye-image is reproduced three times per frame, to deliver smoother moving images on the screen. Aiming to eliminate motion breaking and reduce sequence convolution, this approach increases too much the projection frame rate. The current invention proposes to solve the same problem without increasing the display frame rate above the standard value of 48 FPS per eye.

### SUMMARY

According to an implementation, the method for reducing frame repetition in stereoscopic 3D imaging, includes deriving a left eye (LE) motion blur for an input frame, deriving a right eye (RE) motion blur for the same input frame, deriving a coincidental motion blur (Cmb) for the input frame, and adding the coincidental motion blur (Cmb) to both LE and RE images.

According to another implementation, the apparatus for reducing frame repetition in stereoscopic 3D imaging includes at least one motion blur extraction circuit configured to derive motion blur for an input video frame for each of a left eye (LE) image and a right eye (RE), at least one total motion blur extraction circuit configured to derive a total motion blur for each of the LE image and RE image, a circuit for deriving a coincidental motion blur using the total motion blur extracted for each of the LE image and the RE image, and at least one adder circuit configured to add the input video frame with the coincidental motion blur and a processed version of the total motion blur for each the LE and RE image.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIGS. 1a-1c show a graphical representation of the frame sequences for left eye (LE) and right eye (RE) images at 24, 48 and 72 FPS, respectively;

FIG. 2 is a visualization of the coincidental motion blur (Cmb) for LE and RE images according to an implementation of the present invention;

FIG. 3 is a graphical representation of the coincidental blur for the covered eye with a dark image frame present, according to an implementation of the present invention;

FIGS. 4a and 4b are graphical representations highlighting the non-linear relation between motion blur and object speed;

FIG. 5 is a flow diagram of the method for reducing frame repetition according to an implementation of the present invention; and

FIG. 6 is a block diagram of an apparatus within which the method of the present invention is implemented.

### DETAILED DESCRIPTION

The present invention is directed towards enhancing the reproduction of three-dimensional dynamic scenes on digital light processing (DLP) and (liquid crystal display) LCD projectors and displays by adding optimal amount of motion blur to stimulate the covered eye to continue perceiving scene picture changes. Too much blur would bring smearing, but a lack of blur induces motion breaking.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures can be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, can also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

The Method and Apparatus for Reducing the Frame Repetition in Stereoscopic 3D Imaging improves the quality of three-dimensional video images, played by Digital Cinema projectors in movie theatres. Viewers of those images will see picture reproduction at standard repletion rate of 48 frames per second, which is down from the increased repetition rate of 72 frames per second per eye-image, proposed by other methods.

According to one implementation, the method of the present invention introduces a small increase in a type of motion blur, referred to herein as “coincidental blur”, which is specific for stereography, and relies on some particularities of the Human Visual System in perceiving this blur.

It is known from physiology that the image information from one eye reaches to a smaller degree the brain visual mechanism of the other eye. The existing stereographic art does not take this factor into consideration. The present invention proposes to increase the amount of the coincidental blur which reaches directly the active eye for a given frame, and to utilize the fact that it is perceived by the other eye indirectly, through brain processing, as a reduced amount.

The Method and Apparatus for Reducing the Frame Repetition in Stereoscopic 3D Imaging analyzes in detail the motion scene through the frame sequence, and extracts the scene-object displacement data. The coincidental blur information is valid for both eyes. The increased amount of coincidental blur will contribute for the covered eye to better handle the missing pictorial data for this frame, via image processing in the brain.

The enhancement process can be performed efficiently when an experienced operator selects the amount of coincidental blur and establishes its optimal amount in several viewing iterations. This correction can be implemented by electronic video-mixing equipment at the post-production facility.

In accordance with an implementation of the present invention, the number of the reproduced frames per second is brought down to a standard amount. The method and apparatus of the present invention are designed to improve the perceivable quality of S3D images that represent volumetric dynamic/motion scenes on digital cinema screens.

Those of skill in the art will recognize that there are two (2) categories of methods for quality enhancement of dynamic images in stereoscopic digital cinema theatres, to which the present invention could be compared:

1) Methods for increased Frame Per Second (FPS) rate of reproduced S3D images in digital cinema theatres. The FPS increase for S3D usually is three times per eye-image, compared to the standard 24 FPS rate. Sometimes it is called triple flash, or triple flashing. Frame repetition has been employed for a long time in non-stereoscopic cinema theatre, at the standard 48 FPS for double projection of every frame. The introduction of stereoscopic imagery brought about the need to triple the frame repetition to 72 FPS, or 3×24 FPS per eye-image, in order to avoid the motion breaking, or judder. Thus the total FPS per both eyes is 144 FPS.

The advantage of this method is in achieving smooth reproduction of motion scenes. Disadvantages of the approach could be summarized as follows:
the triple flashing feature is not available in all digital projectors, which limits the method only to high-end devices, and
the increased frame rate, aimed at bringing continuous motion perception, is engaged in all scenes of the movie, including parts of the presentation which contain no significant motion.

2) Methods for adding motion blur to both left-eye-image and right-eye-image of the movie/presentation content. These methods analyze the inter-frame difference during the mastering process and add directional blur to the dynamic objects in the scene. The advantage of this method is that they do not need to increase the frame rate for achieving smooth motion during S3D image projection. The disadvantages are as follows:
the motion blur is not applied selectively. Rather, the enhancement for one of the eye-images highlights the general blur in the displayed frame. Since the fundamental problem to be solved ensues from the insufficient picture elements for the covered eye, this category doesn't offer adaptive improvement in the desired direction; and
the employed motion blur is not categorized for the particularities of the sequential LB-RE stereoscopic projection. The present invention employs methods in line to solve the same problems as identified in category 2, while overcoming the disadvantages of the same.

According to an implementation, a main goal and advantage of the present invention is to use intra-frame and inter-frame motion blur to achieve smooth perception of dynamic S3D images, while using the classic cinematic dual frame flashing, rather than the triple frame flashing currently utilized in stereoscopy.

The method counts on the natural leaking of one eye-image to both optical receiving hemispheres of the human brain, and proposes to utilize this phenomenon by modifying the projected pictures during the phase of image processing in the video domain.

Those of skill in the art will also recognize that it is a scientifically attested fact that the image information from one eye reaches to some extent the visual mechanism behind the retina of the other eye. Thus a mono vision could deliver some volumetric perception. This mechanism is different from the retina image retention and the short-time light-keeping ability of the HVS.

In accordance with one implementation, by reducing the frame refresh rate to 48 FPS per eye-image, the present invention widens the applicability of the method by including video monitors, displays, and TV sets, in the list of possible S3D reproducing devices.

According to an implementation, the present invention proposes to perform the following:

1) to categorize the scene object motion blur as individual motion blur for LE image, or LEmb, and individual motion blur for RE image, or REmb;

2) to recognize that there is a common motion blur, coincidental in the LE and RE images, and to name it Cmb;

3) to introduce a distinction between individual and common motion blur, as being pixel based characterized, and which distinction outlines the blur boundaries in the video frame;

4) to consider the blur distribution in a frame as a separate image, and to process it in post-production through normal video routines and algorithms; and

5) to apply math functions to the Cmb, LEmb, REmb.

As suggested above, existing methods for 3D imaging do not take into consideration the fact that the projection of a picture for one of the eyes sends additional image information to the other eye as well. The present invention seeks to resolve this problem by increasing the amount of the coincidental blur which directly reaches the active eye, and which—through brain processing—is perceived indirectly, in a reduced amount, by the other eye.

According to a preferred implementation, the Method and Apparatus for Reducing the Frame Repetition in Stereoscopic 3D Imaging of the present invention analyzes, in detail, the motion scene presented by the frame sequence, and extracts the directional scene object data, which also constitutes the object displacement data. The coincidental blur information is valid for both eyes. The increased amount of coincidental blur will help the covered eye processing part of the brain to better handle the “dark” frame for this eye.

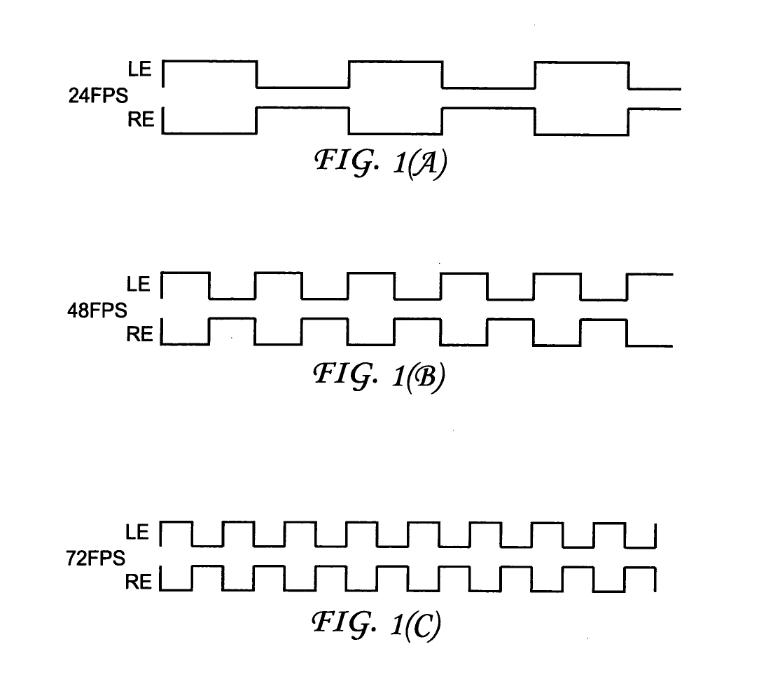

Referring to FIGS. 1a-1c, there is shown the frame sequences of the processes aimed at capturing a scene at the cinematic 24 FPS of the classic double flashing 48 FPS, then the LE-RE image sequence for double stereoscopic flashing, and finally, the triple flashing with resulting total FPS=144. Those of skill in the art will appreciate that the frame sequence diagrams are valid for both DLP-based and LCD based cinema theatre projectors.

The approach of the method of the present invention is based on distinguishing different types of motion blur extant in stereography, and applying selective processing to those blurs in the video domain. There is a variety of known motion detection and motion analysis methods that could be applied to define the object displacement between consecutive frames, including in 3D. The object displacement could be the result of scene motion, of camera zoom and pan, and also of animation in synthesized scenes. These methods require frame buffers to store the LE and RE neighboring frames for comparison. Those of skill in the art will appreciate that the following image processing concepts are the building blocks of the proposed invention.

### Deriving Coincidental Motion Blur

### DEFINITIONS

1) The LE motion blur (LEmb) is a collection of object trails in the left-eye frame sequence, which appears only in the left camera during capture; its sources are the object edges invisible to the right camera. The LEmb is an image, whose pixels are situated around the pixels of solid objects and mainly in a direction opposite to the direction of the object movement. The LEmb pixels are not found in the RE image;

2) The RE motion blur (REmb) is a collection of object trails in the right-eye frame sequence, which appears only in the right camera during capture; its sources are the object edges invisible to the left camera. The REmb is an image, whose pixels are situated around the pixels of solid objects and mainly in a direction opposite to the direction of object movement. The REmb pixels are not found in the LE image;

3) The total LE motion blur (TLEmb) image is a sum of the object trails in the LE frame sequences, visible by both cameras during capture, plus the LEmb motion blur specific for the left eye;

4) The total RE motion blur (TREmb) image is a sum of the object trails in the RE frame sequences, visible by both cameras during capture, plus the REmb motion blur specific for the right eye. Some blur images can be derived through logical and math functions:

TLEmb(−)TREmb

TLEmb(and)TREmb

TLEmb(or)TREmb

5) The coincidental motion blur is a sum of object trails, happening in both frame sequences to a precision of pixel levels. It could be derived as an “and” function:

Coincidental motion blur Total LE motion blur “and” Total RE motion blur or, Cmb=TREmb(AND)TLEmb

Note: This is not a sum but a logical “and” function, which delivers coexisting pixels only.

The Coincidental motion blur (Cmb) created by the present invention is used to convey extra image information to the eye system which does not receive light during the current video frame.

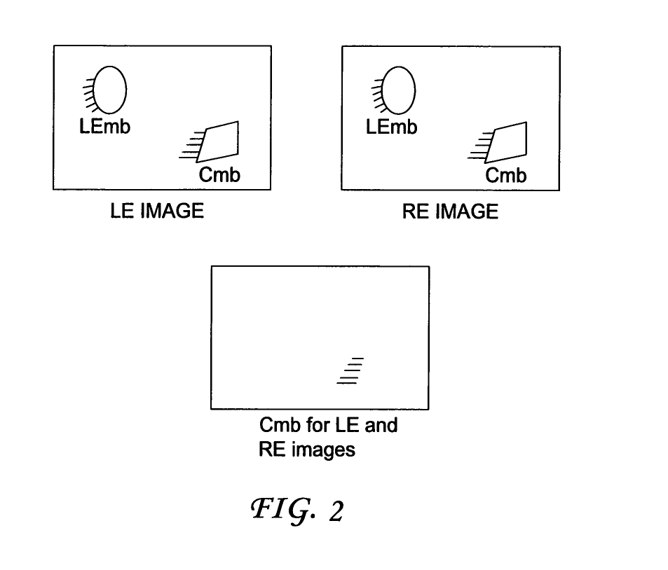

Referring to FIG. 2, there is shown the character of different types of motion blur according to the invention. The coincidental motion blur (Cmb), common for both eye-images, is derived from a pair of LE and RE images, and then a small amount of it is added to any of the total blur to form a corrected value:

TLEmb(corrected)=TLEmb+Cmb

TREmb(corrected)=TRLEmb+Cmb

A frame buffer of one frame is required to conduct the addition, which shapes the final result of the image process algorithm. The projected frame is still one per eye. The relation between the inter-frame difference and the amount of the coincidental motion blur Cmb is not necessarily straightforward. Rather, the relation is non-linear and reflects the perceiving characteristics of the HVS. The method and process to implement this non-linear relation is an important aspect of the present invention. Human eyes take an amount of motion blur proportionally to the object speed, under a logarithmic law. This is valid for S3D imagery as well.

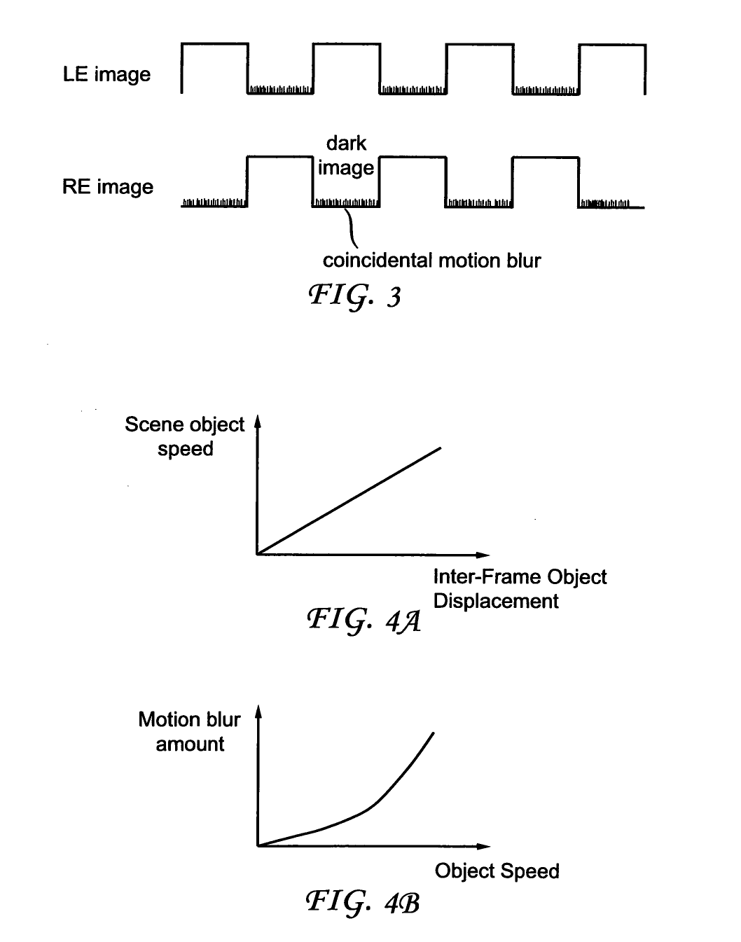

Referring to FIG. 3, there is shown a graphical representation of the position of the coincidental motion blur (Cmb) during a dark frame. Here, it is implied that if the inter-frame video difference is zero, the method doesn't add extra motion blur.

There are a number of known methods for motion analysis, which could be used to define the inter-frame difference, and therefore the total blur. Those of skill in the art will recognize that the principles of the present invention are not restricted to a specific motion analysis method. As the simplest computation of the inter-frame difference, the pixel by pixel inter-frame comparison could be used.

FIGS. 4a and 4b show a graphical representation the non-linear relation between the object speed and the amount of introduced motion blur. FIG. 4a presents the linear correspondence between the scene object speed and the inter-frame object displacement in the image sequence. FIG. 4b shows the non-linear relation between the object speed and the amount of introduced motion blur, as discussed above in this section. The curve is of logarithmic nature, the way the perceiving characteristics of the HVS are.

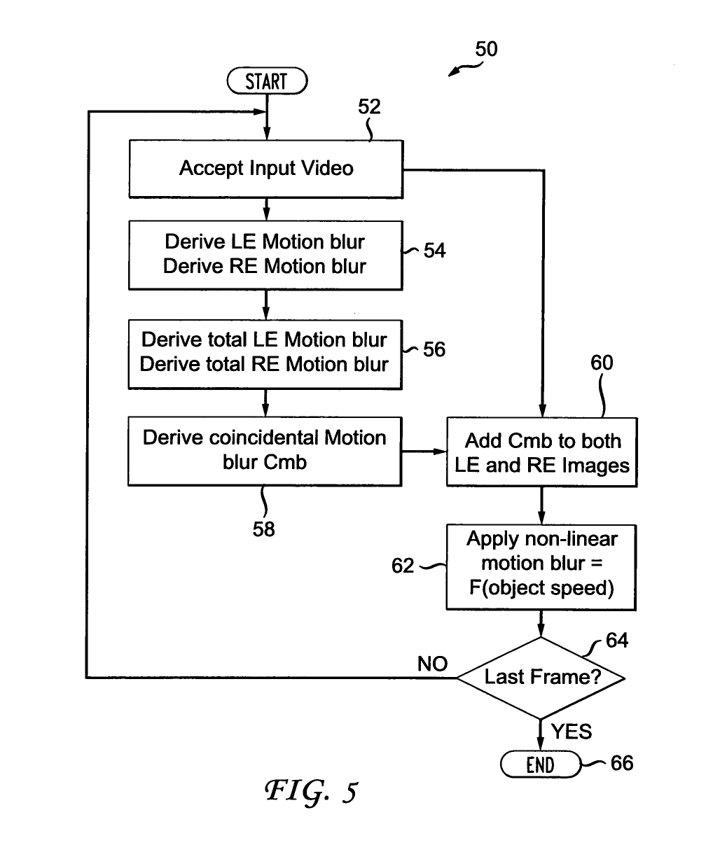

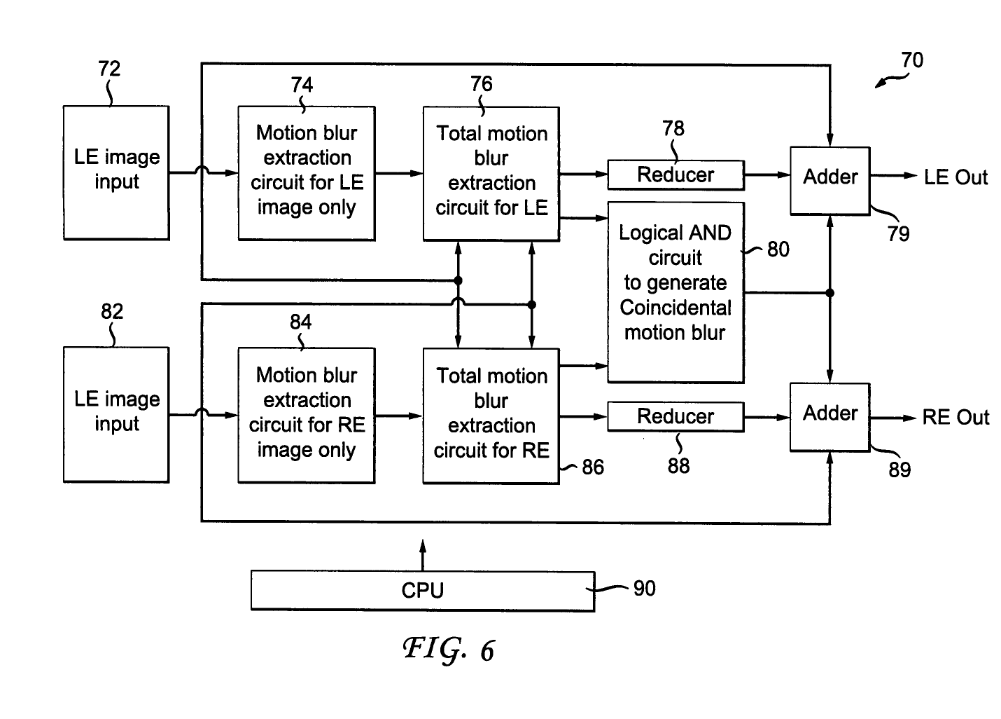

FIG. 5 shows the flow-diagram of the method 50 for reducing frame rate repetition according to an implementation of the present invention. Upon starting of the process, the input video is accepted (52). Once accepted, the LE and RE motion blur are derived (54) and the total LE motion blur and total RE motion blur are derived (56). Once the LE and RE motion blur and total motion blur are derived, the coincidental motion blur (Cmb) is derived (58).

At step 60, the Cmb derived at step 58 is added to both the LE and RE images of the input video. This addition at step 60 operates to add the derived Cmb to the input video. Once this addition is performed, a non-linear motion blur is applied (62) which, as described above, is a function (F) of the object speed. At this stage a determination is made as to whether or not this is the last frame (64), and if yes, the process ends (66). If this is not the last frame (64), then the process begins again at step 52 for the next frame.

FIG. 6 shows a block diagram of an apparatus 70 according to an implementation of the present invention. The input video for the LE (72) and RE (82) is applied to modules 74 and 84, respectively, for extracting the specific motion (i.e., motion blur) for each eye-image. The resulting extracted motion blur is, together with the input video, is passed to a circuit for extracting the total motion blur for each eye (76, 86). This amount is weighted using a reducer (78, 88) and applied to the corresponding adder (79, 89). At the same time, outputs of the Total motion extraction modules 76, 86 is input into the logical AND circuit 80 to generate the coincidental motion blur (Cmb). The Cmb is also input to each adder 79, 89, which adds the input video, weighted outputs of reducers 78, 88 and the determined Cmb to provide the resulting left eye (LE) output and right eye (RE) output. As will be evident, the adders 79, 89 function to apply the non linear motion blur (step 60 in FIG. 5) to provide the respective output. The CPU 90 is in signal communication with all modules shown and controls the image processing throughout the system.

Those of skill in the art will recognize that FIG. 6 is only one example of an implementation of an apparatus according to the present invention. This figure shows separate circuits for left eye (LE) and right eye (RE) image processing. In other contemplated embodiments, the apparatus may include motion blur and total motion blur extraction circuits that are integrated into the same circuit and remain capable of processing the LE and RE images independent of each other.

It is to be understood that the present invention can be implemented in various forms of hardware, software, firmware, special purpose processors, or a combination thereof. Preferably, the present invention would be implemented as a combination of hardware and software. Moreover, the software is preferably implemented as an application program tangibly embodied on a program storage device. The application program can be uploaded to, and executed by, a machine comprising any suitable architecture. Preferably, the machine would be implemented on a computer platform having hardware such as one or more central processing units (CPU), a random access memory (RAM), and input/output (110) interface(s). The computer platform also includes an operating system and microinstruction code. The various processes and functions described herein may either be part of the microinstruction code, or part of the application program (or a combination thereof), which is executed via the operating system. In addition, various other peripheral devices may be connected to the computer platform, such as an additional data storage device, and a printing device.

It is to be further understood that, because some of the constituent system components and method steps depicted in the accompanying figures are preferably implemented in software, the actual connections between the system components (or the process steps) may differ depending on the manner in which the present invention is programmed. The proposed innovations would not require a special training: The average operator in the related art will be able to utilize these and similar implementations or configurations of the present invention with the aid of the guidelines alone.

These and other features and advantages of the present principles can be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software can be implemented as an application program tangibly embodied on a program storage unit. The application program can be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform can also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for reducing frame repetition in stereoscopic 3D imaging, the method comprising the steps of:
deriving a left eye motion blur for an input frame;
deriving a right eye motion blur for the same input frame;
deriving a coincidental motion blur for the input frame; and
adding the coincidental motion blur to both the LE and RE images.

2. The method of claim 1, wherein said the step of deriving coincidental motion blur further comprises:
deriving a total LE motion blur from the derived LE motion blur; and
deriving a total RE motion blur from the derived RE motion blur.

3. The method of claim 1, further comprising:
applying a non-linear motion blur to the LE and RE images with the Cmb added;
determining whether the input frame is the last frame; and
ending the method when it is determined the input frame is the last frame.

4. The method of claim 3, further comprising repeating all of said steps when it is determined that the input frame is not the last frame.

5. The method of claim 1, wherein said deriving a left eye motion blur further comprises collecting object trails in a left-eye sequence and which appear in a left camera during capture.

6. The method of claim 1, wherein said deriving a right eye motion blur further comprises collecting object trails in a right-eye frame sequence and which appear in a right camera during capture.

7. The method of claim 2, wherein said deriving a total LE motion blur further comprises;
adding object trails in LE frame sequences visible by both a left and a right camera during capture and the LE motion blur specific for the left eye.

8. The method of claim 2, wherein said deriving a total RE motion blur further comprises:
adding object trails in RE frame sequences visible by both a left and a right camera during capture and the RE motion blur specific for the right eye.

9. The method of claim 2, wherein the deriving of the coincidental motion blur further comprises:
logically ANDing the derived total LE motion blur with the derived total RE motion blur.

10. An apparatus for reducing frame repetition in stereoscopic 3D imaging, the apparatus comprising:
at least one motion blur extraction circuit configured to derive motion blur for an input video frame for each of a left eye image and a right eye;
at least one total motion blur extraction circuit configured to derive a total motion blur for each of the LE image and RE image;
a circuit for deriving a coincidental motion blur using the total motion blur extracted for each of the LE image and the RE image; and
at least one adder circuit configured to add the input video frame with the coincidental motion blur and a processed version of the total motion blur for each the LE and RE image.

11. The apparatus of claim 10, further comprising at least one circuit for weighting the total motion blur for each of the LE and RE image to produce the processed version of the respective LE and RE images.

12. The apparatus of claim 11, wherein the at least one adder applies a non-linear motion blur to LE and Re images with the Cmb added to produce the processed version of the respective LE and RE images.

13. The apparatus of claim 10, wherein said at least one motion blur extraction circuit collects object trails in a right eye sequence and which appears in a right camera during capture.

14. The apparatus of claim 10, wherein said at least one motion blur extraction circuit collects object trails in a left eye sequence and which appears in a left camera during capture.

15. An apparatus for reducing frame repetition in stereoscopic 3D imaging, the apparatus comprising the steps of:
means for deriving a left eye motion blur for an input frame;
means for deriving a right eye motion blur for the same input frame;
means for deriving a coincidental motion blur for the input frame; and
means for adding the coincidental motion blur to both LE and RE images.

16. The apparatus of claim 15, wherein said deriving coincidental motion blur further comprises:
means for deriving a total LE motion blur from the derived LE motion blur; and
means for deriving a total RE motion blur from the derived RE motion blur.

17. The method of claim 15, further comprising:
means for applying a non-linear motion blur to the LE and RE images with the Cmb added;
means for determining whether the input frame is the last frame; and
means for ending the method when it is determined the input frame is the last frame.
